(19) United States
(12) Patent Application Publication
(10) Pub. No.: US 2008/0038036 A1
(43) Pub. Date: Feb. 14, 2008

(54) PRINTER HAVING A PRINTHEAD WITH FIXED ANGLE

(76) Inventor: Sheng-Chih Lin, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/611,898

(22) Filed: Dec. 18, 2006

(30) Foreign Application Priority Data
Aug. 10, 2006 (TW) 095129379

(51) Int. Cl. B41J 25/316; B41J 25/304

(52) U.S. Cl. 400/120.17; 400/120.16

(57) ABSTRACT

Card printer having a horizontal platform and an angle-fixing platform allows for adjusting the angle-fixing platform's horizontal location on the horizontal platform. An inclined plane on the angle-fixing platform can fix a printhead of the printer for providing heaters on the printhead a best contact angle with a ribbon and a card. The printhead assembly of the card printer requires only the adjustment of the horizontal location of the printhead and it realizes quality control for printing with single parameter on a card printer.

### BACKGROUND OF THE INVENTION

1. Field of the Invention

The present invention relates to a printer, and more specifically, to a printer having a printhead with fixed angle.

2. Description of the Prior Art

A card printer uses a conveying roller, or a set of conveying rollers, to convey a card to where the printhead is located and then an elevator in the printing mechanism controls the printhead to exert pressure on the conveying roller, so that the printhead can transfer data onto the card. As the printhead completes transferring data of one color onto the card, the elevator raises the printhead and the card is conveyed back to the original place by the conveying roller for a next color transferring.

The printhead contacts the card in a long and narrow plane, and the angle and the horizontal location of the printhead is often adjustable such that the printhead can have an optimal contact angle with the card, in other words, the printhead can exert a maximum pressing force on the card through the contact plane in a certain angle, which accordingly the contact plane generally lies rather on a neighboring location parallel to the contact line between the card and the conveying roller than on the contact line. The adjustability allows the printhead of the printer to have a best contact location and a best contact angle with the card. The adjustment of the horizontal location and the adjustment of the angle of the printhead interact with each other, however. When the printhead is adjusted to have the best contact angle, the contact plane between the printhead and the card may not lie on the best contact location and therefore, the printhead needs a further horizontal adjustment. After the successive horizontal adjustment of the printhead is done, the angle of the printhead may again deviate from its best contact angle with the card due to the manufacturing inaccuracy. The adjustment of the printhead of the printer in the prior art is quite complicated and difficult to get an accurate control.

### SUMMARY OF THE INVENTION

The claimed invention provides a printer having a printhead with fixed angle. The printer comprises a bracket, a printing body installed on the bracket, a horizontal platform installed on the printing body, an angle-fixing platform having an inclined plane, fixed on the horizontal platform capable of moving horizontally, and a printhead installed on the inclined plane of the angle-fixing platform.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an illustration of the printer having a printhead with fixed angle according to the present invention.

FIG. 2 is an illustration of the side view of the printer in FIG. 1.

FIG. 3 is an illustration of the printer when a card is conveyed backward.

FIG. 4 is an illustration of a printhead assembly, a card, and a conveying roller.

### DETAILED DESCRIPTION

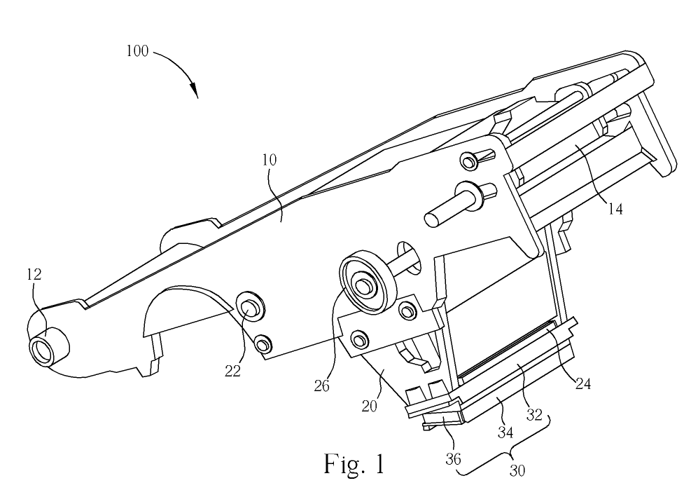

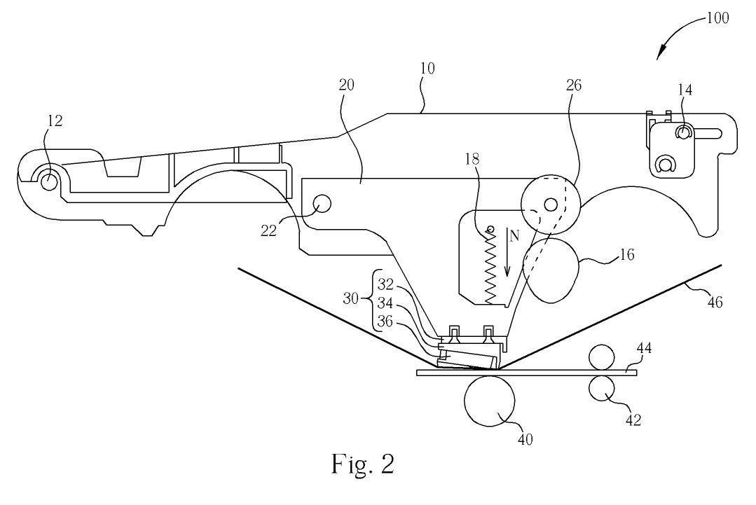

Please refer to FIG. 1 and FIG. 2. FIG. 1 is an illustration of the printer 100 having a printhead with fixed angle according to the present invention. FIG. 2 is an illustration of the side view of the printer 100. The printer 100 comprises a bracket 10, a printing body 20, a printhead assembly 30, a conveying roller 40, and a set of driving rollers 42. The bracket 10 can be opened and closed along the rotary shaft 12 and when the bracket 10 is opened, replacement of a ribbon cartridge can be done. The bracket 10 further comprises a latch 14 that ensures the bracket 10 can lock in the printer 100 when the latch 14 buckles up a housing (not shown in the figure) of the printer 100. In addition, the bracket 10 can be locked by the latch 14 so as to provide a horizontal platform for the printing body 20.

The printing body 20 is fixed on the bracket 10 through a connecting shaft 22 and rotatable along the connecting shaft 22. The overall printing process can be divided into two stages: card printing stage and card conveying stage. In the card printing stage, a printhead 36 on the printer 100 pushes the ribbon 46 to contact the card 44 and transfer ink onto the card 44. In the card conveying stage, the ribbon 46 is not contacting the card 44 such that the card 44 can be conveyed back to the original location by the driving rollers 42. Hence, the printer 100 further includes an imposing element 18 connected between the bracket 10 and the printing body 20 with an first end fixed on the printing body 20 and a second end fixed on the bracket 10. The imposing element 18 pushes the printing body 20 in the direction of N from the bracket 10, causing the printhead 36 to push the ribbon 46 to contact the card 44 in the card printing stage. In the card conveying stage, in order that the card 44 should be conveyed by the driving rollers 42 without contacting the ribbon 46 to mess up the printed pattern on the card 44, the printing body 20 should be lifted up (opposite to direction N) and also lift up the printhead 26 along with the ribbon cartridge and its ribbon 46. This can be achieved by a cam 16 installed on the bracket 10 of the printer 100 rotating to a position that interferes with an idler 26 and pushing the idler 26 to move up along the direction opposite to direction N, forcing the printing body 20 to rotate on the connecting shaft 22 around the bracket 10 so that the printhead 36 and the ribbon 46 can rise and not contact the card 44. When the cam 16 rotates further and not interferes with the idler 26, the printing body 20 is pushed by the imposing element 18 and brings the printhead 36 to move in the direction N. Practically, the imposing element 18 can be a spring or any element capable of providing thrust.

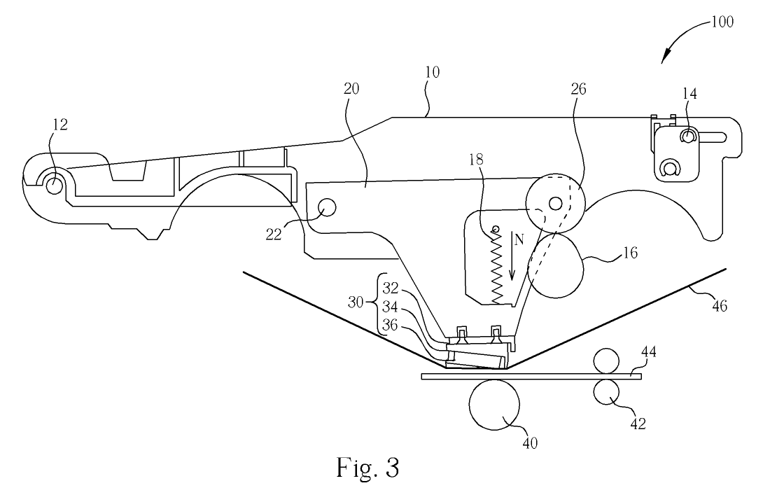

FIG. 3 is an illustration of the printer 100 when the card 44 is conveyed backward and separated from the printhead 36 and the ribbon 46.

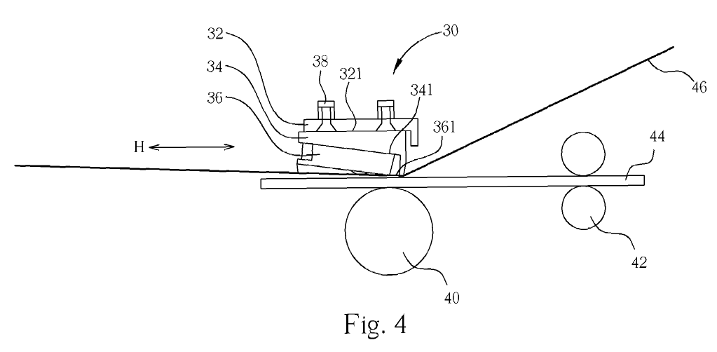

To more specifically describe how the present invention uses an angle-fixing platform 34 to hold the printhead 36, please refer to FIG. 4, which is an illustration of the printhead assembly 30, the card 44, and the conveying roller 40. The printhead assembly 30 comprises a horizontal platform 32, an angle-fixing platform 34, and a printhead 36. The horizontal platform 32 is fixed on a platform 24 of the printing body 20 through a fixing element 38, as FIG. 2 shows, where the fixing element 38 can be a plurality of screws. In addition, the fixing element 38 is also used for locking the angle-fixing platform 34 on a horizontal plane 321 of the horizontal platform 32, where the angle-fixing platform 34 is horizontally adjustable on the horizontal plane 321. The angle-fixing platform 34 further has an inclined plane 341 where the printhead 36 is installed.

Because of the tilting angle of the inclined plane 341, a heater 361 on the printhead 36 can have a best contact angle with the card 44 when the printhead 36 is installed on the inclined plane 341. And because the horizontal location of the angle-fixing platform 34 can be adjusted due to the angle-fixing platform 34 is moving horizontally on the horizontal platform 32, as the direction H in FIG. 4, the best contact angle between the heater 361 and the card 44 will not be affected by the horizontal movement of the angle-fixing platform 34. The heater 361 of the printhead 36 is always maintaining the best contact angle with the card 44 when the printhead 36 is horizontally adjusted. Generally the maximum pressing force by the heater 361 exerted on the card 44 and the conveying roller 40 occurs when the heater 361 is located slightly from the contact line between the card 44 and the conveying roller 40. Through adjusting the horizontal location of the printhead 36, i.e., adjusting the horizontal location of the angle-fixing platform 34 on the horizontal platform 32 along the direction H, the heater 361 of the printhead 36 can move to a best location for providing the maximum pressing force on the card 44. With one single parameter needed to be adjusted, the present invention controls the printhead 36 to have a best contact location and a best contact angle with the card 44.

The printer disclosed in the present invention applies not only for outputting photos but any other kinds of output that a dye sublimation printer can do. With the horizontal platform and the angle-fixing platform, the printer allows for adjusting the angle-fixing platform's horizontal location on the horizontal platform. The inclined plane on the angle-fixing platform can fix the printhead of the printer for providing heaters on the printhead the best contact angle with the ribbon and the card. The printhead assembly of the card printer requires only the adjustment of the horizontal location of the printhead and it realizes quality control for printing with single parameter on a card printer.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A printer having a printhead with fixed angle, comprising:
a bracket;
a printing body installed on the bracket;
a horizontal platform installed on the printing body;
an angle-fixing platform having an inclined plane, fixed on the horizontal platform capable of moving horizontally; and
a printhead installed on the inclined plane of the angle-fixing platform.

2. The printer of claim 1 further comprising a connecting shaft for connecting the bracket and the printing body.

3. The printer of claim 2 further comprising:
a cam installed on the bracket; and
an idler installed on the printing body for being pushed by the cam, thereby forcing the printing body to rotate on the connecting shaft around the bracket.

4. The printer of claim 1 further comprising an imposing element having a first end fixed on the printing body and a second end fixed on the bracket.

5. The printer of claim 4, wherein the imposing element is a spring.

6. The printer of claim 1, wherein the horizontal platform further comprises a fixing element for locking the angle-fixing platform on the horizontal platform.

7. The printer of claim 6, wherein the fixing element is a screw.
